(19) United States
(12) Patent Application Publication
(10) Pub. No.: US 2017/0212569 A1
(43) Pub. Date: Jul. 27, 2017

(54) LOAD DISCOVERY

(71) Applicant: HEWLETT PACKARD ENTERPRISE DEVELOPMENT LP, Houston, TX (US)

(72) Inventors: David C. Valdez, Houston, TX (US); Han Wang, Sugar Land, TX (US); James A. Fuxa, Houston, TX (US)

(21) Appl. No.: 15/328,375

(22) PCT Filed: Oct. 31, 2014
(86) PCT No.: PCT/US2014/063401

§ 371 Date: Jan. 23, 2017

(51) Int. Cl. G06F 1/26; H02J 9/06; G06F 1/32

(52) U.S. Cl. CPC G06F 1/263; G06F 1/266; G06F 1/3287; G06F 1/3206; H02J 9/06

(57) ABSTRACT

Example implementations relate to load discovery. For example, a load discovery system can include a shared backup power supply controlled by a backup power control module, and a node coupled to the shared backup power supply, wherein the node supports a plurality of loads, and the shared backup power supply powers the plurality of loads when the node is powered off, and a baseboard management control (BMC) unit coupled to the node, the BMC unit to discover the plurality of loads.

### BACKGROUND

As reliance on computing systems continues to grow, so too does the demand for reliable power systems and back-up schemes for these computing systems. Servers, for example, may provide architectures for backing up data to flash or persistent memory as well as back-up power sources for powering backup of data after the loss of power. Backup power supplies may sometimes include energy components such as capacitors or batteries.

### BRIEF DESCRIPTION OF THE DRAWINGS

FIG. 1 illustrates a block diagram of an example of a system for load discovery, according to the present disclosure;

FIG. 2 illustrates an example of a load discovery system, according to the present disclosure;

FIG. 3 illustrates a flow diagram of a shared backup power supply powering a plurality of loads during load discovery and BMC unit communication, according to the present disclosure; and

FIG. 4 illustrates a flow diagram of an example of a method for load discovery, according to the present disclosure.

### DETAILED DESCRIPTION

A computing data storage system can include a number of nodes that support a number of loads. The nodes can be a number of servers, for example. A number of loads can include storage controllers or devices associated with the servers. For example, a load can include cache memory, dual inline memory modules (DIMMs), Non-Volatile Dual In-Line Memory Modules (NVDIMMs), and/or array control logic, among other storage controllers and/or devices associated with the servers. A computing data storage system can include a backup power system operatively coupled to the number of nodes to support the number of loads in an event of a removal of a primary power supply.

A removal of a primary power supply can be scheduled or un-scheduled. For instance, a scheduled removal of the primary power supply can be the result of scheduled maintenance on the number of nodes and/or the number of loads. A scheduled removal of the primary power supply can be an intentional power down of the number of nodes and/or the number of loads to add and/or remove nodes to a chassis and/or network connected to a primary power supply. In another example, a scheduled removal of the primary power supply can be an intentional power down to add and/or remove one or more loads to or from one or more nodes.

An un-scheduled primary power supply removal can be a failure in the primary power supply. An un-scheduled primary power supply removal can occur when, for example, the primary power supply fails momentarily and/or for an extended period of time.

It may be desirable to move data from cache memory in the number of nodes to non-volatile memory upon the removal of a primary power supply. However, moving data from cache memory to non-volatile memory can involve a power supply. A shared backup power supply can be a secondary power supply that is used to provide power for moving data from cache memory to non-volatile memory when the primary power is removed. It may also be desirable to enable the shared backup power supply to configure itself based on the number of nodes it is supporting, in order to improve performance of the shared backup power supply.

Previous solutions involved a Field Replaceable Unit (FRU) system, which can only provide limited information regarding an associated plurality of loads to the storage controller(s) without a main power supply (e.g., direct current power). In contrast, examples of the present disclosure can include a load discovery system that includes an uninterruptible power supply portion and a shared back-up power supply portion to power a number of nodes. A plurality of loads associated with the node can be discovered and the shared backup power supply can power the plurality of loads when the node is powered off.

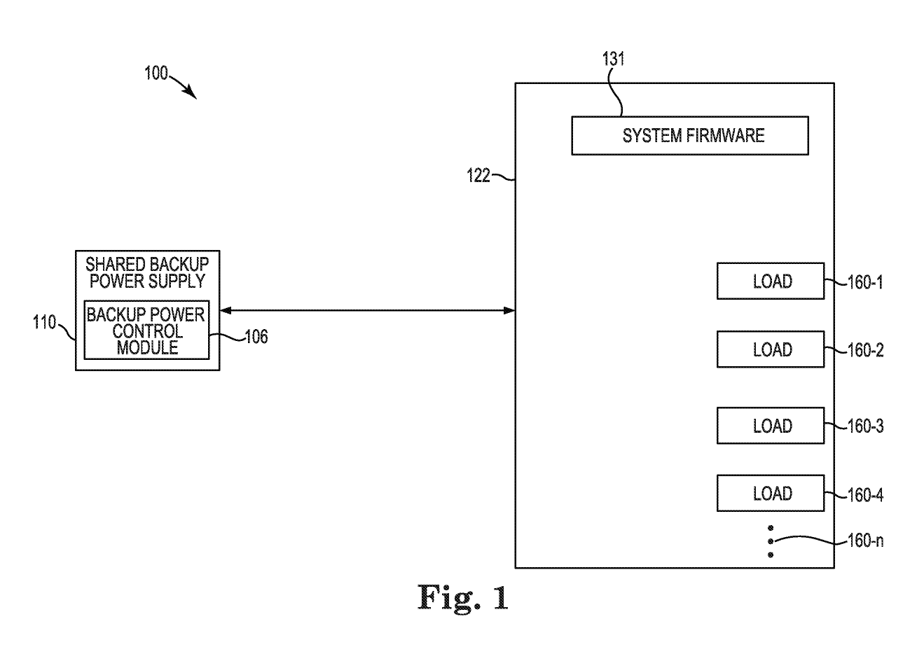

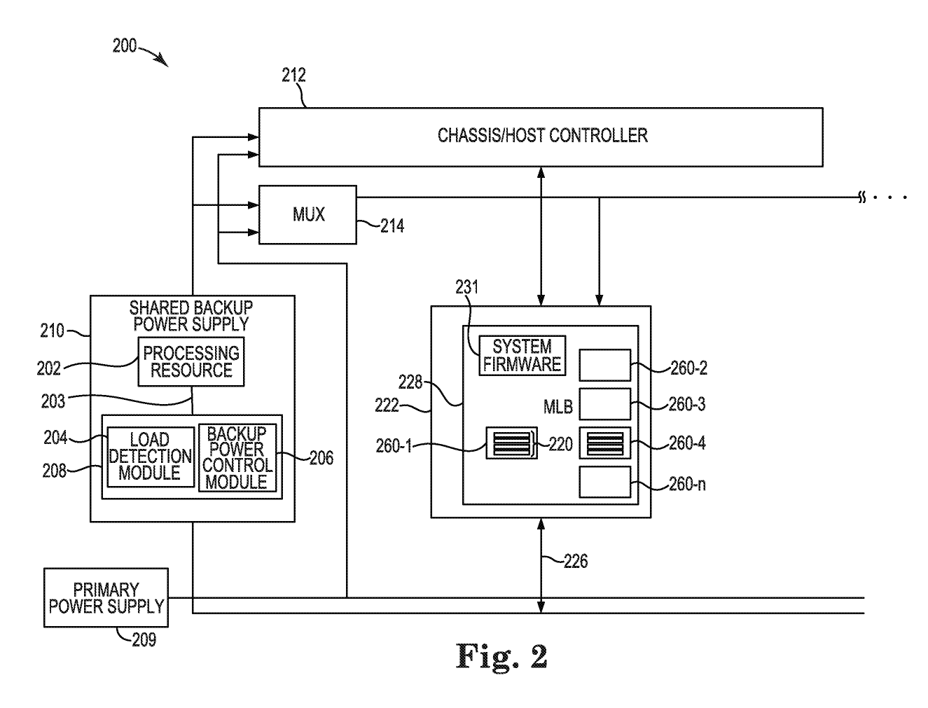

FIG. 1 illustrates a block diagram of an example of a system 100 for load discovery according to the present disclosure. As illustrated in FIG. 1, the system 100, can include a shared backup power supply 110 and a node 122 coupled to the shared backup power supply 110. The shared backup power supply 110 can be controlled by a backup power control module 106, as discussed further in relation to FIGS. 2, 3, and 4. The node 122 can support a plurality of loads 160 (e.g., load 160-1, load 160-2, load 160-3, load 160-4, and load 160-N collectively referred to herein as loads 160). The shared backup power supply 110 can power the plurality of loads 160 when the node 122 is powered off.

The node 122 can include system firmware 131 that enables communication between the shared backup power supply 110 and the plurality of loads 160. In some examples, the backup power control module 106 that controls the shared backup power supply 110 can be located internal to the node 122. System firmware 131 can be computer executable instructions stored on the node 122. Examples of system firmware can include Basic Input/Output System (BIOS), and a baseboard management control (BMC) unit. BIOS provides initialization and testing of the hardware components of the node 122 and loads an operating system for the node when it is powered on. The BMC unit can be a specialized microcontroller embedded on the motherboard of the node 122, and that manages the interface between system management software and platform hardware.

In some examples, a BMC unit can discover the plurality of loads 160. Discovery of the plurality of loads 160 refers to the identification and/or connection of each load among the plurality of loads 160 to the node 122. That is, all loads associated (e.g., connected, affiliated, etc.) with the node 122 can be identified by the BMC unit. Further, the node 122 can be configured based on the discovered plurality of loads 160. Configuration can include power allocation, power optimization, among other features, as discussed further in association with FIGS. 2, 3, and 4.

While examples herein use BIOS and the BMC unit as examples of system firmware 131, examples of the present disclosure are not so limited. Other types of system firmware 131 can be used to perform the various examples described in this disclosure. Furthermore, while specific examples are outlined herein, describing actions performed by BIOS and by the BMC unit, examples are not limited. Actions described as being performed by BIOS can be performed by a BMC unit and/or other types of system firmware 131. Similarly, actions described as being performed by a BMC unit can be performed by BIOS and/or other types of system firmware 131.

The system firmware 131 can discover the plurality of loads 160 that are associated with (e.g., connected to) the node 122. For example, prior to the node 122 powering on, BIOS can determine a plurality of loads 160 that are associated with the node 122 and which are powered by the shared backup power supply 110. The BIOS can communicate, via the BMC unit, identification of the plurality of loads 160 that receive power from the shared backup power supply 110 and which may be associated with the node 122. For instance, the BIOS can determine, prior to the node 122 powering on via a primary power source, that loads 160-1 and 160-2 receive backup power from the shared backup power supply 110. In response to determining that loads 160-1 and 160-2 receive backup power from the shared backup power supply 110, the BIOS can communicate identification of loads 160-1 and 160-2 to the node 122 upon initialization. As used herein, initialization refers to powering on, such as from receiving power from a power source and powering on.

Examples are not so limited, however, and each load among the plurality of loads 160 can be identified. For instance, in some examples of the present disclosure, the shared backup power supply 110 can sequentially power the plurality of loads 160, from which the BIOS can determine associated load connections to the node 122. As used herein, sequentially powering the plurality of loads 160 refers to powering each load among the plurality of loads 160 in a particular order (e.g., load 160-1, load 160-2, load 160-2, etc.). That is, the BIOS can identify each load among the plurality of loads 160 associated with the node 122 based on a particular powering sequence.

The sequential powering of each load among the plurality of loads 160 can assist in identifying loads associated with the node 122 by creating an identification (e.g., a pattern) of the presence of each load among the plurality of loads 160. Presence, as used herein, refers to a load being associated with a node such as the particular load 160-1 being connected to the node 122.

For example, a node may have ten potential load associations, yet only six of the ten are associated with a load among the plurality of loads 160 (e.g., as used in this example, ten). Powering a first load among the plurality of loads 160 can indicate presence or non-presence of the first load. The powering sequence can continue throughout the plurality of loads 160 to create a presence and/or non-presence identification for each load among the plurality of loads 160 (e.g., as used in this example, six of the ten can indicate a presence, four of the ten can indicate a non-presence).

The system firmware 131 can perform a number of other functions related to load discovery. In some examples, the shared backup power supply 110 can exclusively power the plurality of loads 160 associated with the node 122. That is, the plurality of nodes 122 can be exclusively powered by the shared backup power supply 110 prior to the node powering initializing (e.g., powering “on”). As used herein, exclusive powering refers to the shared backup power supply powering the plurality of loads 160 and no other component. The exclusive powering of the plurality of loads 160 can conserve the shared backup power supply 110 and create a more efficient power allocation to the plurality of loads 160 upon node 122 initialization as compared to a power allocation without previous load discovery.

FIG. 2 illustrates an example of a load discovery system according to the present disclosure. As illustrated in FIG. 2, the node 222 can host a plurality of loads (e.g., loads 260-1, 260-2, 260-3, 260-4, collectively referred to herein as loads 260). For instance, the node 222 can include a number of devices, such as local memory or data storage (e.g., referred generally as memory). The memory may contain volatile and non-volatile memory, e.g., cache and non-volatile memory dual inline memory modules (NVDIMM). Thus, each memory in the node 222 can contain a number of NVDIMM slots 220. Each NVDIMM slot among the number of NVDIMM slots 220 can provide a load to the system 200. Node 222 can include other devices such as cache memory, DIMMs, array control logic, and storage controllers, among other devices associated with the node 222, and each of the devices associated with the node 222 can provide a load to the system 200. For instance, load 260-2 can be provided by a storage controller, whereas each NVDIMM slot among the number of NVDIMM slots 220 can provide load 260-1. In some examples, the node 222 can also include a control logic unit (not illustrated in FIG. 2). In some examples, the control logic can be coupled to the node via a control signal and power lines 226. For example, the node 222 can provide a signal to the signal lines 226 when data is to be backed up to non-volatile memory.

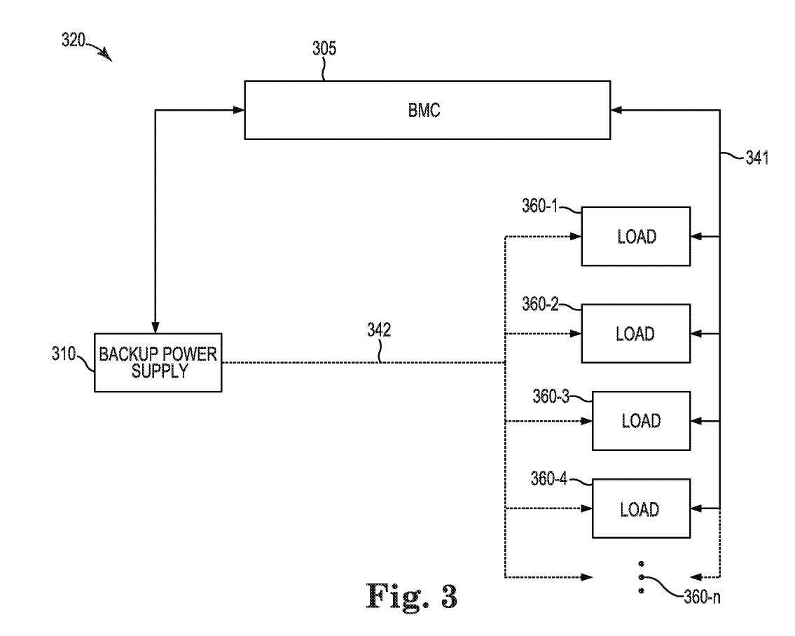

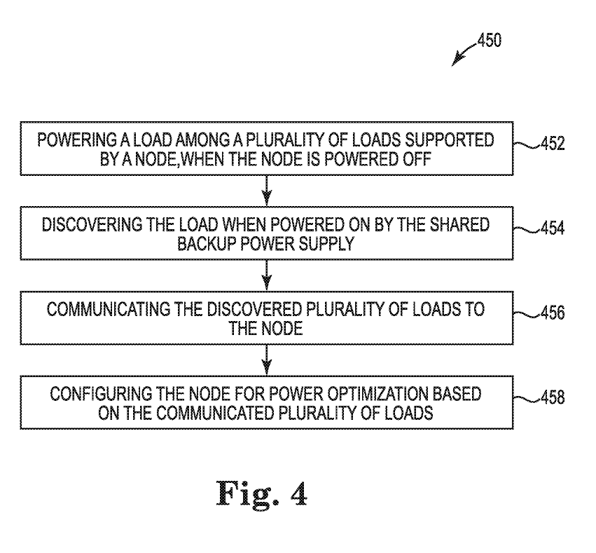

The shared backup power supply 210 can include a processing resource 202 connected via a connection 203 to a memory resource 208, e.g., a computer-readable medium (CRM), machine readable medium (MRM), database, etc. In some examples, memory resource 208 may be a non-transitory storage medium, where the term “non-transitory” does not encompass transitory propagating signals. The memory resource 208 can include a number of computing modules. The example of FIG. 2 shows a load detection module 204 and a backup power control module 206. As used herein, a computing module can include program code, e.g., computer executable instructions, hardware, firmware, and/or logic. A computing module at least includes instructions executable by the processing resource 202, e.g., in the form of modules, to perform particular actions, tasks, and functions described in more detail herein in reference to FIGS. 3 and 4.

Instructions associated with a particular module, e.g., load detection module 204 and backup power control module 206, when executed by the processing resource 202 can also be referred to and function collectively as a component and/or computing engine. As used herein, an engine can include hardware firmware, logic, and/or executable instructions. But an engine at least includes hardware e.g., logic in the form of an application specific integrated circuit (ASIC), to perform particular actions, tasks and functions described in more detail herein in reference to FIGS. 3 and 4.

Engines and/or the number of modules, e.g., load detection module 204 and backup power control module 206 shown in FIG. 2, can be sub-engines/modules of other engines/modules and/or combined to perform particular actions, tasks, and functions within a particular system and/or computing device. Engines and/or modules described herein can be located in a single system and/or computing device or reside in separate distinct locations in a distributed computing environment, e.g., cloud computing environment.

The system 200 can perform a number of functions and operations as described in FIGS. 3 and 4, and include the apparatus and methods for load discovery as described herein.

The shared backup power supply 210 can be a battery that is external or internal to the node 222 and external to the chassis/host controller 212 supporting the node 222. The shared backup power supply 210 can provide power to the plurality of loads 260. In some examples, the shared backup power supply 210 can exclusively power the plurality of loads 260 associated with the node 222. As used herein, exclusively powering the plurality of loads 260 refers to the shared backup power supply 210 providing power to the plurality of loads 260 and no other components within system 200. That is, in some examples, the shared backup power supply 210 can be exclusive to the plurality of loads 260. In some examples, the shared backup power supply 210 can support the node 222 and/or different chassis/host controllers, e.g., not shown, and different MUXs (not shown) to support a plurality of nodes on different chassis.

The node 222 can include a main logic board (MLB) 228, and the MLB 228 can include system firmware 231. The system firmware 231 can include a number of components, such as BIOS and/or a BMC unit. The system firmware 231 can allow the node 222 to communicate with the shared backup power supply 210. For instance, the system firmware 231 can include a BMC unit. As described herein, a BMC unit can be a specialized microcontroller embedded on the motherboard of the node 222, and that manages the interface between system management software and platform hardware. For example, using the BMC unit, the plurality of loads 260 that can be powered by the shared backup power supply 210 and power optimization settings can be communicated to the node 222. As used herein, a power optimization setting refers to a configuration of a power setting for each load among the plurality of loads.

The MLB 228 components can allow the BMC unit and the shared backup power supply 210 to communicate with the node 222 and the chassis/host controller 212. In some examples, the BMC unit can guide the load discovery. For example, the BMC unit can communicate from BIOS to the shared backup power supply 210, the discovered plurality of loads 260. In response to discovery of the loads 260, the discovered loads can be powered by the shared backup power supply 210. That is, the plurality of loads 260 associated with the node 222 can be powered on by the shared backup power supply 210 and identified by the BMC unit.

Furthermore, the system firmware 231 can facilitate communication between the shared backup power supply 210 and the plurality of loads 260, as discussed further in relation to FIGS. 3 and 4.

The backup power control module 206 can have instructions stored in a non-transitory storage medium (e.g., memory resource 208) that include powering the plurality of loads 260 associated with a node 222 via the shared backup power supply 210 in a sequential order when the node 222 is powered off. Using a BMC unit coupled to the node 222, the plurality of loads 260 can be discovered and the node 222 can be configured based on the discovered plurality of loads 260.

The load detection module 204 can have instructions stored in a non-transitory storage medium (e.g., memory resource 208) to communicate between the system firmware 231 and the node 222, the discovered plurality of loads 260 that are associated with the node 222. In some examples, the instructions can include identifying each load among the plurality of loads 260 in a sequential order when the node 222 is powered off.

Further, the load detection module 204 can have instructions stored in a non-transitory storage medium (e.g., memory resource 208) to use the system firmware 231 (such as a BMC unit), in response to a sequential powering of each load among the plurality of loads 260, to communicate the identification of the discovered plurality of loads 260 to the node 222.

In some examples, the plurality of loads 260 can be powered by the shared backup power supply 210. The powering of the plurality of loads 260 can identify each load among the plurality of loads 260 that is associated with the node 222. In response to the identified plurality of loads, the BMC unit can configure power optimization upon node 222 initialization. Also, the backup power control module 206 can communicate the discovered plurality of loads 260 to the node 222.

In a number of examples, the backup power control module 206 can use the system firmware 231 to provide a threshold of time during which the shared backup power supply 210 can provide a power supply to the plurality of loads 260. The threshold of time can be a pre-set threshold of time, such as 60 seconds.

As used herein, a pre-set threshold of time refers to a threshold of time specified by a program or user. However, examples are not so limited, and the threshold of time can be a range of pre-determined time periods, such as between 60 seconds and 5 minutes. That is, the power supply to the plurality of loads 222 from the shared backup power supply 210 can be finite and limited in scope.

The BMC unit can also identify the plurality of loads 260 that are to be protected with backup power from the shared backup power supply 210, and configure the shared backup power supply 210 to provide backup power to the loads. The power provided to the plurality of loads 260 during the threshold of time can be limited to complete load discovery. Once the plurality of loads 260 are discovered, instructions executable by the processing resource 202 can include turning the node 222 on, and configuring the node 222 based on the number of discovered loads.

In some examples, the backup power control module 206 can communicate information regarding the power usage and/or optimization of the shared backup power supply 210 to the plurality of loads 260, such as power allocation and/or usage. In response to the discovery of the plurality of nodes 260, the backup power control module 206 can receive, from the system firmware 231 and based on the powering of each of the plurality of loads 260, an indication of each load among the plurality of loads 260 associated with the node 222. The node 222 can be configured (e.g., power optimization, usage, etc.) based on each load among the plurality of loads 260.

FIG. 3 illustrates a flow diagram 320 of a shared backup power supply 310 powering a plurality of loads (360-1, 360-2, 360-3, 360-4, . . . , 360-N, collectively referred to herein as loads 360) during load discovery and BMC unit 305 communication, according to the present disclosure. FIG. 3 illustrates the communication between the components, and battery power provided by the shared backup power supply 310 to the plurality of loads 360, and is not intended to illustrate structural components, as such components are illustrated in FIGS. 1 and 2.

As shown in FIG. 3, line 342 illustrates the battery power provided by the shared backup power supply 310 to the plurality of loads 360. The shared backup power supply 310 can power each load among the plurality of loads 360.

Line 341 illustrates the communication path between the plurality of loads 360 and the BMC unit 305. As each load among the plurality of loads 360 is powered on, the BMC unit 305 can discover the presence or non-presence of each load among the plurality loads 360. That is, the BMC unit 305 can identify each load among the plurality of loads 360 that are associated with the node.

For example, as illustrated in FIG. 3, the BMC unit 305 can identify the presence or non-presence of each load among the plurality of loads 360. Once the presence or non-presence of each load among the plurality of loads 360 is determined, the BMC unit 305 can communicate all of the discovered loads to the node and configure power optimization. For instance, power optimization can include power allocation to each load among the plurality of loads 360 upon node initialization.

While FIG. 3 illustrates the use of a BMC unit 305 to communicate between the shared backup power supply 310 and the plurality of loads 360 associated with the node, examples are not so limited, and other system firmware can be used to communicate load discovery information to the node.

FIG. 4 illustrates a flow diagram of an example of a method 450 for load discovery according to the present disclosure. At 452, the method 450 can include powering a load among a plurality of loads (e.g., loads 160-1, 160-2, 160-3, 160-4, and 160-n illustrated in FIG. 1) supported by a node when the node is powered off. In some examples, the load can be powered for threshold of time, using a shared backup power supply (e.g., shared backup power supply 110 illustrated in FIG. 1). The threshold of time can be user-configurable, for example.

Further, as described herein, the plurality of loads connected to the node can be powered sequentially. That is, each load among the plurality of loads can be powered in a particular order.

At 454, the method 450 can include, discovering, using a BMC unit coupled to the node, the load when powered on by the shared backup power supply. For example, the plurality of loads can be powered for a threshold of time, sequentially or non-sequentially, and the BMC unit can discover loads associated with the node based on the powering of the loads. The BMC unit can communicate the discovered plurality of loads to the node. That is, prior to powering the node using a primary power source, powering the loads individually can indicate a load among the plurality of loads that are associated with the node. Powering each load among the plurality of loads can indicate a presence or non-presence of the load, as discussed previously in FIG. 1.

At 456, the method 450 can include communicating the discovered plurality of loads to the node upon the node initialization. That is, the node can initialize (e.g., power on), and the BIOS can communicate the discovered plurality of loads to the node. The node may then be aware of the associated plurality of loads and configure power allocations and/or power optimization accordingly. For example, the node can configure a power allocation to each individual load among the plurality of loads for efficiency purposes.

At 458, the method 450 can include configuring the node for power optimization based on the communicated plurality of loads. For example, the BMC unit can determine a rate level for the node and/or the plurality of loads. As used herein, a rate level is a rate of power allocation and/or power usage designated for the node and/or the plurality of loads. In some examples, power optimization can include configuring a power setting for each load among the plurality of loads.

In the foregoing detailed description of the present disclosure, reference is made to the accompanying drawings that form a part hereof, and that is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, the designators “N” and “P”, particularly with respect to reference numerals in the drawings, indicate that a number of the particular feature so designated can be included with a number of examples of the present disclosure. Further, as used herein, “a number of” an element and/or feature can refer to one or more of such elements and/or features.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

The above specification, examples and data provide a description of the method and applications, and use of the system and method of the present disclosure. Since many examples may be capable of being made without departing from the spirit and scope of the system and method of the present disclosure, this specification merely sets forth some of the many possible example configurations and implementations.

What is claimed:

1. A load discovery system, comprising:
a shared backup power supply controlled by a backup power control module;
a node coupled to the shared backup power supply, wherein:
the node supports a plurality of loads; and
the shared backup power supply powers the plurality of loads when the node is powered off; and
a baseboard management control (BMC) unit coupled to the node, the BMC unit to discover the plurality of loads.

2. The system of claim 1, wherein the shared backup power supply powers the plurality of loads in a sequential order to discover the plurality of loads.

3. The system of claim 2, wherein the shared backup power supply exclusively powers the plurality of loads associated with the node.

4. The system of claim 1, wherein the BMC unit determines a rate level and power optimization among the plurality of loads.

5. The system of claim 1, wherein the backup power control module is located internal to the node.

6. The system of claim 1, wherein the BMC unit defines at least one of a rate level, a power setting, a power optimization, a software update, and a firmware update.

7. A non-transitory machine readable medium storing instructions executable by a processing resource to cause a computer to:
power, using a shared backup power supply, a plurality of loads of a node that are protected by the shared backup power supply in a sequential order when the node is powered off;
discover the plurality of loads using a baseboard management control (BMC) unit coupled to the node; and
configure the node based on the plurality of loads.

8. The medium of claim 7, wherein the plurality of loads associated with the node are discovered based on a sequential powering of each of the plurality of loads.

9. The medium of claim 7, further comprising instructions to power the node after the plurality of loads are discovered.

10. The medium of claim 7, wherein the instructions executed to discover the plurality of loads includes instructions executable to power each of the plurality of loads for a threshold of time, wherein the threshold of time is user configurable.

11. The medium of claim 10, wherein the threshold of time provides power to the plurality of loads for a particular time for load discovery.

12. A method of load discovery, comprising:
powering, using a shared backup power supply, a load among a plurality of loads supported by a node for a user-configurable threshold of time when the node is powered off;
discovering the plurality of loads when powered on by the shared backup power supply using a baseboard management control (BMC) unit coupled to the node;
communicating the discovered plurality of loads to the node upon initialization of the node; and
configuring the node for power optimization based on the discovered plurality of loads.

13. The method of claim 12, wherein configuring the node for power optimization includes determining a rate of power allocation to the plurality of loads.

14. The method of claim 12, wherein configuring power optimization includes configuring a power setting for each load among the plurality of loads.

15. The method of claim 12, wherein the plurality of loads connected to the node are powered sequentially in a particular order using the shared backup power supply.
